(19) United States
(12) Patent Application Publication
(10) Pub. No.: US 2007/0247579 A1
(43) Pub. Date: Oct. 25, 2007

(54) LIQUID CRYSTAL DISPLAY

(76) Inventors: Seon-Ah Cho, Busan-si (KR); Ji-Won Sohn, Seoul (KR); Nak-Cho Choi, Seoul (KR)

Correspondence Address: MACPHERSON KWOK CHEN & HEID LLP, 2033 GATEWAY PLACE, SUITE 400, SAN JOSE, CA, 95110, US

(21) Appl. No.: 11/736,380

(22) Filed: Apr. 17, 2007

(30) Foreign Application Priority Data
Apr. 19, 2006 (KR) 10-2006-0035223

(51) Int. Cl. G02F 1/1343; G02F 1/1337

(52) U.S. Cl. 349/139; 349/129

(57) ABSTRACT

A liquid crystal display is provided, which includes: a first insulating substrate; a gate line formed on first insulating substrate; a data line intersecting gate line; a thin film transistor connected to gate line and the data line; a pixel electrode connected to the thin film transistor and having a plurality of slits; a second insulating substrate facing first insulating substrate; a slope member disposed on the location corresponding to the corner of pixel electrode and formed on second insulating substrate; a common electrode formed on second insulating substrate; and a liquid crystal layer formed between the common electrode and pixel electrode.

### CROSS-REFERENCE TO RELATED APPLICATION

This application claims priority to and the benefit of Korean patent application no. 10-2006-0035223 filed in the Korean intellectual property office on Apr. 19, 2006, the contents of which are incorporated herein by reference.

### FIELD OF THE INVENTION

The present invention relates to a liquid crystal display.

### DESCRIPTION OF THE RELATED ART

A liquid crystal display (LCD) includes two panels provided with pixel electrodes, a common electrode and a liquid crystal (LC) layer between the electrodes. Images are displayed by applying voltages to the electrodes to generate an electric field in the LC layer that determines the orientation of the molecules in the LC layer and the hence the polarization of incident light.

Among the LCDs, the vertical alignment (VA) mode LCD, which aligns LC molecules such that the long axes of the LC molecules are perpendicular to the panels in the absence of an electric field, is important because of its high contrast ratio and wide reference viewing angle.

The wide viewing angle of the VA mode LCD can be realized by providing cutouts and protrusions on the field-generating electrodes that distribute the tilt directions of the LC molecules in various directions such that the reference viewing angle is widened.

However, because a portion of the LC molecules may be not influenced by the fringe field produced by cutouts, the molecules may be arranged in arbitrary directions by the driving voltage resulting in collisions of the LC molecules and producing an afterimage.

### SUMMARY OF THE INVENTION

The present invention provides a liquid crystal display having improved display characteristics by maximizing the number of LC molecules influenced by the fringe field, thereby minimizing collisions and the concomitant afterimage effect. A liquid crystal display is provided which includes a first insulating substrate; a gate line formed on first insulating substrate; a data line intersecting gate line; a thin film transistor connected to gate line and the data line; a pixel electrode connected to the thin film transistor and having a plurality of slits; a second insulating substrate facing first insulating substrate; a slope member disposed on the location corresponding to the corner of pixel electrode and formed on second insulating substrate; a common electrode formed on second insulating substrate; and a liquid crystal layer formed between the common electrode and pixel electrode.

The slits may obliquely extend from right and left edges of pixel electrode to the imaginary longitudinal and vertical center lines of pixel electrode. It is preferable that the plane shape of the slope member is circular or polygonal, and that the slope member decreases in height from its center to its edge.

It is preferable that the molecules of the liquid crystal display under the slits be tilted in the longitudinal direction of the slits and that the width of the slits be in the range from about 3 to 4 μm.

A liquid crystal display is provided, which includes a first insulating substrate; a gate line formed on first insulating substrate; a data line intersecting gate line; a thin film transistor connected to gate line and the data line; a pixel electrode connected to the thin film transistor and having a plurality of sub-pixel electrodes; a second insulating substrate facing first insulating substrate; a slope member formed on second insulating substrate; a common electrode formed on second insulating; and a liquid crystal layer formed between the common electrode and pixel electrode.

### BRIEF DESCRIPTION OF THE DRAWING

The foregoing and other objects and features of the present invention will become more apparent from the ensuing description when read with the drawing, in which:

FIG. 1 is a layout view of an LCD according to an embodiment of the present invention;

FIG. 2 is a layout view of a TFT array panel of an LCD shown in FIG. 1 according to an embodiment of the present invention;

FIG. 3 is a layout view of a common electrode panel of an LCD shown in FIG. 1 according to an embodiment of the present invention;

FIG. 4 is a sectional view of the LCD shown in FIG. 1 taken along the line IV-IV;

FIG. 5 is a sectional view of the LCD shown in FIG. 1 taken along the line V-V;

FIG. 6 is a layout view of an LCD according to another embodiment of the present invention;

FIG. 7 is a layout view of a TFT array panel of an LCD shown in FIG. 6 according to an embodiment of the present invention;

FIG. 8 is a layout view of a common electrode panel of an LCD shown in FIG. 6 according to an embodiment of the present invention;

FIG. 9 is a sectional view of the LCD shown in FIG. 6 taken along the line IX-IX; and

FIG. 10 is a sectional view of the LCD shown in FIG. 6 taken along the line X-X.

### DETAILED DESCRIPTION OF EMBODIMENTS

In the drawing, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present. In contrast, when an element is referred to as being “directly on” another element, there are no intervening elements present.

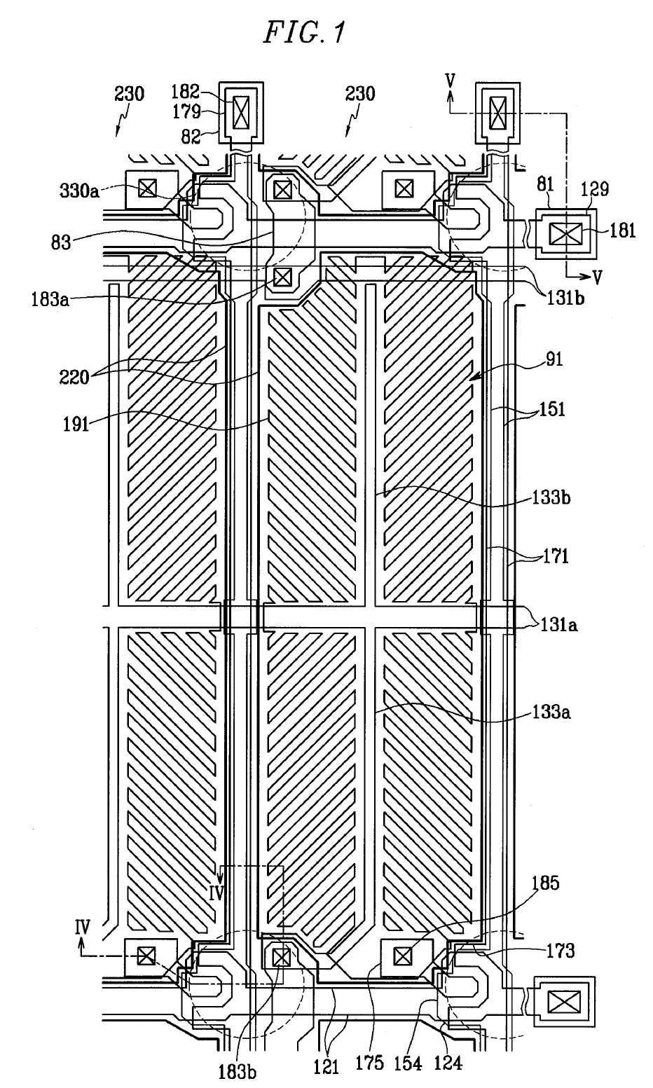

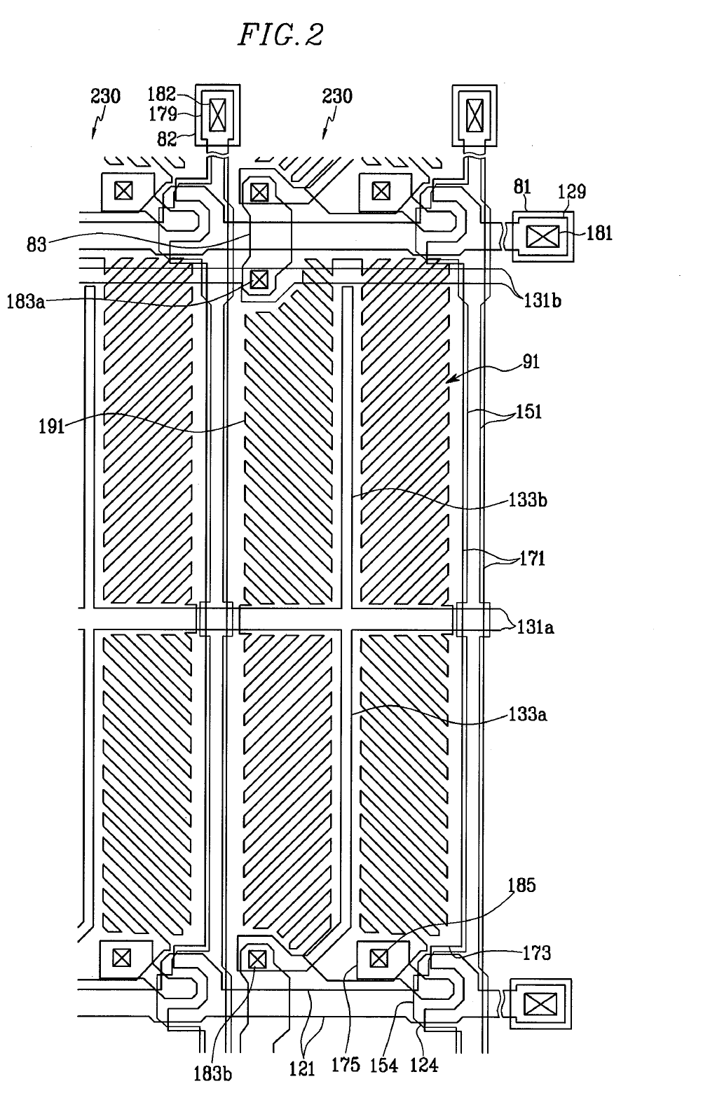

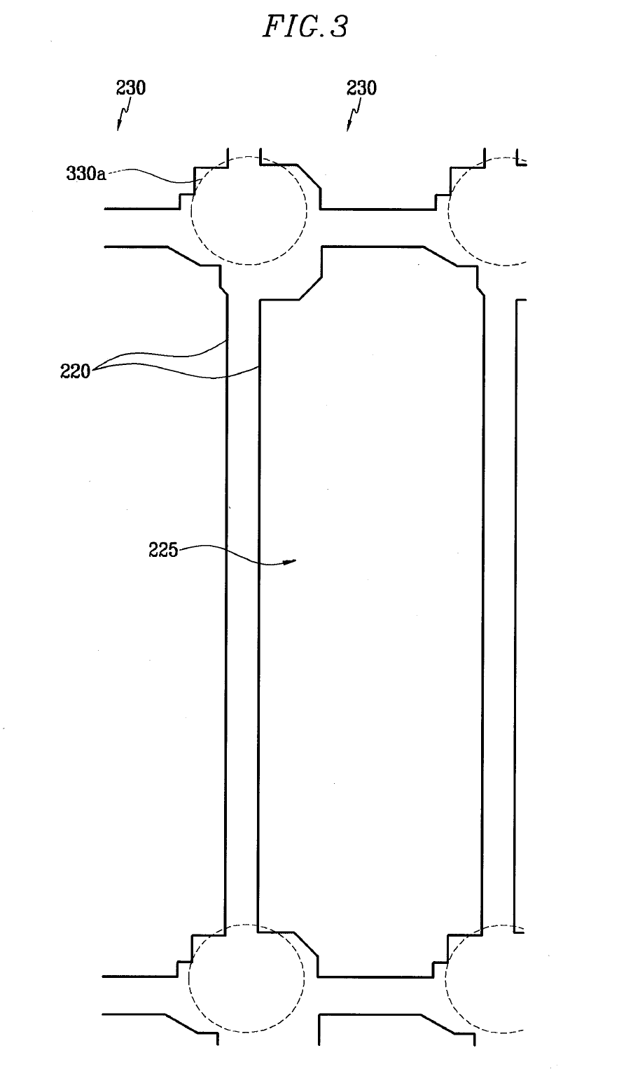

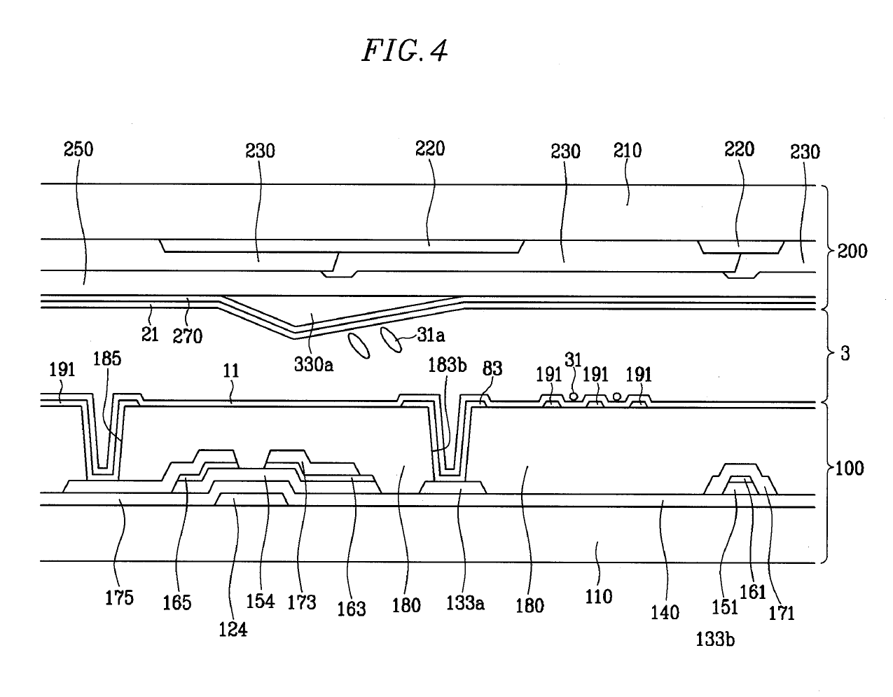

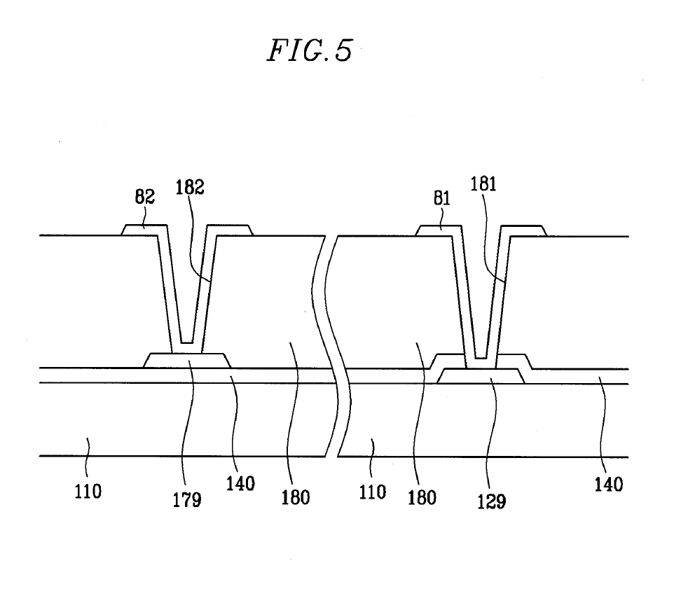

An LCD according to an embodiment of the present invention will be described in detail with reference to FIGS. 1 to 5. FIG. 1 is a layout view of an LCD according to an embodiment of the present invention, FIG. 2 is a layout view of a TFT array panel of an LCD shown in FIG. 1 according to an embodiment of the present invention, FIG. 3 is a layout view of a common electrode panel of an LCD shown in FIG. 1 according to an embodiment of the present invention, FIG. 4 is a sectional view of the LCD shown in FIG. 1 taken along the line IV-IV, and FIG. 5 is a sectional view of the LCD shown in FIG. 1 taken along the line V-V.

An LCD according to an embodiment of the present invention includes a TFT array panel 100, a common electrode panel 200, and an LC layer 3 interposed between the panels 100 and 200. A plurality of gate lines 121 and a plurality of storage electrode lines are formed on an insulating substrate 110 made of a material such as transparent glass.

Gate lines 121 extend substantially in a transverse direction, and are separated from each other and transmit gate signals. Each gate line 121 includes a plurality of projections forming a plurality of gate electrodes 124 projecting upward and downward, and an end portion 129 having a large area for contact with another layer or an external driving circuit. A gate driving circuit (not shown) for generating gate signals may be mounted on a flexible printed circuit (FPC) film (not shown), which may be attached to the substrate 110, directly mounted on the substrate 110, or integrated into the substrate 110. Gate lines 121 may extend to be connected to a driving circuit that may be integrated with the substrate 110.

Storage electrode lines are supplied with a predetermined voltage, and each of storage electrode lines includes first and second storage electrode lines 131a and 131b extending substantially parallel to gate lines 121. First storage electrode lines 131a are disposed on the center portion between two adjacent gate lines 121 and second storage electrode lines 131b are disposed closer to an upper one of the two gate lines 121. Each first storage electrode line 131a includes a plurality of first and second storage electrodes 133a and 133b extending to two adjacent gate lines 121 from first storage electrode line 131a. First and second storage electrodes 133a and 133b are respectively extended in downward and upward directions from first storage electrode line 131a. First storage electrode 133a includes a vertical portion connected to first storage electrode line 131a, an oblique portion extended from the vertical portion, and an expansion portion connected to the end portion of the oblique portion. However, storage electrode lines 131a and 131b may have various shapes and arrangements.

Gate lines 121 and storage electrode lines 131a and 131b are preferably made of an Al-containing metal such as Al and an Al alloy, a Ag-containing metal such as Ag and a Ag alloy, a Cu-containing metal such as Cu and a Cu alloy, a Mo-containing metal such as Mo and a Mo alloy, Cr, Ti, or Ta. Gate lines 121 and storage electrode lines 131a and 131b may have a multi-layered structure including two films having different physical characteristics. One of the two films is preferably made of a low resistivity metal including an Al-containing metal, a Ag-containing metal, and a Cu-containing metal for reducing signal delay or voltage drop in gate lines 121 and storage electrode lines 131a and 131b. The other film is preferably made of a material such as a Mo-containing metal, Cr, Ta, or Ti, which has good physical, chemical, and electrical contact characteristics with other materials such as indium tin oxide (ITO) or indium zinc oxide (IZO). Good examples of the combination of the two films are a lower Cr film and an upper Al alloy film, and a lower Al film and an upper Mo film. However, gate line 121 and storage electrode lines 131a and 131b may be made of various metals or conductors.

In addition, the lateral sides of gate lines 121 and storage electrode lines 131a and 131b are inclined relative to a surface of the substrate, and the inclination angle thereof is in a range of about 30 to 80 degrees.

A gate insulating layer 140 preferably made of silicon nitride (SiNx) is formed on gate lines 121 and storage electrode lines 131a and 131b.

A plurality of semiconductor stripes 151 preferably made of hydrogenated amorphous silicon (abbreviated to “a-Si”) or polysilicon are formed on gate insulating layer 140. Each semiconductor stripe 151 extends substantially in the longitudinal direction and has a plurality of projections 154 branched out toward gate electrodes 124. Semiconductor stripes 151 become wider near gate lines 121 and storage electrode lines 131a and 131b such that semiconductor stripes 151 cover large areas of gate lines 121 and storage electrode lines 131a and 131b.

A plurality of ohmic contact stripes and islands 161 and 165 preferably made of silicide or n+ hydrogenated a-Si heavily doped with an n-type impurity such as phosphorous are formed on semiconductor stripes 151. Each ohmic contact stripe 161 has a plurality of projections 163, and the projections 163 and ohmic contact islands 165 are located in pairs on the projections 154 of semiconductor stripes 151.

The lateral sides of semiconductor stripes 151 and ohmic contacts 161 and 165 are inclined relative to a surface of the substrate, and the inclination angles thereof are preferably in a range of about 30 to 80 degrees.

A plurality of data lines 171 and a plurality of drain electrodes 175 separated from data lines 171 are formed on ohmic contacts 161 and 165 and gate insulating layer 140.

Data lines 171 for transmitting data voltages extend substantially in the longitudinal direction, crossing gate lines 121 and storage electrode lines 131a and 131b at right angles. Each data line 171 includes an end portion 179 having a large area for contact with another layer or an external device. A data driving circuit (not shown) for generating the data signals may be mounted on an FPC film (not shown), which may be attached to the substrate 110, directly mounted on the substrate 110, or integrated into the substrate 110. Data lines 171 may extend to be connected to a driving circuit that may be integrated on the substrate 110. Each data line 171 includes a plurality of source electrodes 173 projecting with a “C” shape toward drain electrodes 175.

Each drain electrode 175 includes an end portion having a large area for contact with another layer and another end portion disposed on a gate electrode 124 and partly enclosed by a source electrode 173.

A gate electrode 124, a source electrode 173, and a drain electrode 175 along with a projection 154 of a semiconductor stripe 151 form a TFT having a channel formed in the projection 154 disposed between the source electrode 173 and drain electrode 175.

Data lines 171, and drain electrodes 175 are preferably made of a refractory metal such as Cr, Mo, Ti, Ta, or alloys thereof. However, they may also have a multilayered structure including a low-resistivity film (not shown) and a good-contact film (not shown). A good example of the combination is a lower Mo film, an intermediate Al film, and an upper Mo film, as well as the above-described combinations of a lower Cr film and an upper Al—Nd alloy film and a lower Al film and an upper Mo film. However, data lines 171, and drain electrodes 175 may be made of various metals or conductors.

Like gate lines 121 and storage electrode lines 131, data lines 171 and drain electrodes 175 have tapered lateral sides, and the inclination angles thereof are in a range of about 30 to 80 degrees.

Ohmic contacts 161 and 165 are interposed only between the underlying semiconductor stripes 151 and the overlying data lines 171 and the overlying drain electrodes 175 thereon, and reduce contact resistance therebetween. Semiconductor stripes 151 include a plurality of exposed portions, which are not covered with data lines 171 and drain electrodes 175, such as portions located between the source electrodes 173 and drain electrodes 175. Although semiconductor stripes 151 are narrower than data lines 171 at most places, the width of semiconductor stripes 151 becomes larger near gate lines 121 and storage electrode lines 131a and 131b as described above to smooth the profile of the surface, thereby preventing disconnection of data lines 171. Semiconductor stripes 151 include some exposed portions, which are not covered with the data conductors 171 and 175, such as portions located between the source electrodes 173 and drain electrodes 175.

A passivation layer 180 is formed on data lines 171, drain electrodes 175, and the exposed portions of semiconductor stripes 151. Passivation layer 180 is preferably made of an inorganic insulator such as silicon nitride or silicon oxide, a photosensitive organic material having a good flatness characteristic, or a low dielectric insulating material having a dielectric constant lower than 4.0 such as a-Si:C:O and a-Si:O:F formed by plasma enhanced chemical vapor deposition (PECVD). Passivation layer 180 may include a lower film of an inorganic insulator and an upper film of an organic insulator such that it takes the excellent insulating characteristics of the organic insulator while preventing the exposed portions of semiconductors 154 from being damaged by the organic insulator.

Passivation layer 180 has a plurality of contact holes 182 and 185 exposing the end portions 179 of data lines 171, and the end portions of drain electrodes 175, respectively. Passivation layer 180 and gate insulating layer 140 have a plurality of contact holes 181 exposing the end portions 129 of gate lines 171, a plurality of contact holes 183a exposing portions of second storage electrode lines 131b, and a plurality of contact holes 183b exposing the expansions of first storage electrodes 133a.

A plurality of pixel electrodes 191, a plurality of contact assistants 81 and 82, and a plurality of overpasses 83, which are preferably made of a transparent conductor such as ITO or IZO or a reflective conductor such as Ag or Al, are formed on the passivation layer 180.

Pixel electrodes 191 are physically and electrically connected to drain electrodes 175 through contact holes 185 such that pixel electrodes 191 receive the data voltages from drain electrodes 175.

Pixel electrodes 191 supplied with the data voltages generate electric fields in cooperation with a common electrode 270, which determine the orientations of liquid crystal molecules in the liquid crystal layer 3.

A pixel electrode 191 and the common electrode 270 of the common electrode panel 200 form a liquid crystal capacitor, which stores applied voltages after turn-off of the TFT. An additional capacitor called a “storage capacitor,” which is connected in parallel to the liquid crystal capacitor, is provided for enhancing the voltage storing capacity. The storage capacitors are implemented by overlapping pixel electrodes 191 with storage electrode lines 131a and 131b.

Each pixel electrode 191 has approximately a rectangular shape and a plurality of cutouts 9. Cutouts 91 are opened at the edges of pixel electrode 191. Cutouts are parallel to each other, and obliquely extend from right and left edges of pixel electrode 191 to storage electrodes 133a and 133b. Cutouts 91 make an angle of about 45 degrees to gate lines 121, and cutouts 91 substantially have inversion symmetry with respect to storage electrodes 133a and 133b and first storage electrode lines 131a. Cutouts 91 range in width from about 3 to 4 μm.

The number of cutouts 91 of pixel electrode 191 may vary according to design factors such as a size of pixel electrode 191, the ratio of lengths of the transverse and longitudinal sides of pixel electrode 191, and the types or characteristics of the liquid crystal layer 3.

Overpasses 83 cross over gate lines 121, and are connected to the exposed portions of second storage electrode lines 131b and the expansions of first storage electrodes 133a through contact holes 183b and 183a, respectively, which are disposed opposite each other with respect to gate lines 121.

Contact assistants 81 and 82 are connected to end portions 129 of gate lines 121 and end portions 179 of data lines 171 through contact holes 181 and 182, respectively. Contact assistants 81 and 82 protect the end portions 129 and 179 and complement the adhesion of the end portions 129 and 179 and external devices.

A description of the common electrode panel 200 follows with reference to FIGS. 1, 3, and 5.

A light blocking member 220 called a black matrix for preventing light leakage is formed on an insulating substrate 210 made of a material such as transparent glass. The light blocking member 220 includes a plurality of openings 225 that face pixel electrodes 191, and has substantially the same planar shape as pixel electrodes 191. Otherwise, the light blocking member 220 may include linear portions corresponding to data lines 171 and gate lines 121, and other portions corresponding to the TFTs.

A plurality of color filters 230 are formed on the substrate 210, and they are disposed substantially in the areas enclosed by the light blocking member 220. The color filters 230 may extend substantially along the longitudinal direction along pixel electrodes 191. The color filters 230 may represent one of the primary colors such as red, green, and blue.

An overcoat 250 for preventing the color filters 230 from being exposed and for providing a flat surface is formed on the color filters 230 and the light blocking member 220. The overcoat 250 may be omitted.

A plurality of slope members 330a preferably made of an insulator are formed on the overcoat 250. The slope members 330a have a circular shape, as drawn with the dotted line in FIGS. 1 and 3, and have inclined surfaces with decreasing heights from the center portion to the edge portion. The plane shape may alternatively be polygonal.

The slope members 330a are disposed on the portions corresponding to the TFTs or the corners of pixel electrodes 191, and may be one body with the overcoat 250.

Common electrode 270, which is preferably made of a transparent conductive material such as ITO and IZO, is formed on the overcoat 250 and the slope members 330a.

Alignment layers 11 and 21 that may be homeotropic are coated on inner surfaces of the panels 100 and 200, and polarizers (not shown) may be provided on outer surfaces of the panels 100 and 200 such that their polarization axes may be crossed and one of the transmissive axes may form an angle of about 45 degrees with cutouts of pixel electrodes 191. One of the polarizers may be omitted when the LCD is a reflective LCD.

The LCD may further include at least one retardation film (not shown) for compensating the retardation of the LC layer 3. The retardation film has birefringence and retards opposite to the LC layer 3. The retardation film may include a uniaxial or biaxial optical compensation film, and in particular, a negative uniaxial compensation film.

The LCD may further include a backlight unit (not shown) for supplying light to the LC layer 3 through the polarizers, the retardation film, and the panels 100 and 200.

It is preferable that the LC layer 3 have negative dielectric anisotropy such that the LC molecules in the LC layer 3 are aligned with their long axes substantially perpendicular to the surfaces of the panels 100 and 200 in the absence of an electric field. Accordingly, incident light cannot pass the crossed polarization system.

Upon application of the common voltage to the common electrode 270 and a data voltage to pixel electrodes 191, an electric field that is substantially perpendicular to the surfaces of the panels 100 and 200 is generated. The LC molecules tend to change their orientations in response to the electric field such that their long axes are perpendicular to the field direction. Common electrode 270 and pixel electrodes 191 are used as field-generating electrodes.

Cutouts 91 of pixel electrodes 191 distort the electric field to form a horizontal component that is substantially perpendicular to the edges of cutouts 91.

The narrow width of cutouts 91, about 3-4 μm, causes the electric fields at the edges of cutouts to offset each other so that the LC molecules are influenced by the shapes of cutouts 91 rather than by the electric field due to cutouts 91.

Accordingly, the LC molecules are tilted in a direction parallel to the edges of cutouts 91 rather than the perpendicular direction of the edges of cutouts 91 and the azimuthal distribution of the tilt directions are localized to about four directions, thereby increasing the viewing angle of the LCD.

The LC molecules 31a are pre-tilted by the slope members 330a with arbitrary directions in the absence of the electric field. Accordingly, when the slope members 330a are disposed at the corners of pixel electrodes 191, the pre-tilt directions of the LC molecules 31a determine the tilt directions of the LC molecules 31 upon application of the electric field, which coincide with the tilt directions determined by cutouts 91, and therefore the response time of the LC molecules 31 may be increased.

At least one of cutouts 91 can be substituted with protrusions (not shown) or depressions (not shown). The protrusions are preferably made of an organic or inorganic material and are disposed on or under the field-generating electrodes 191.

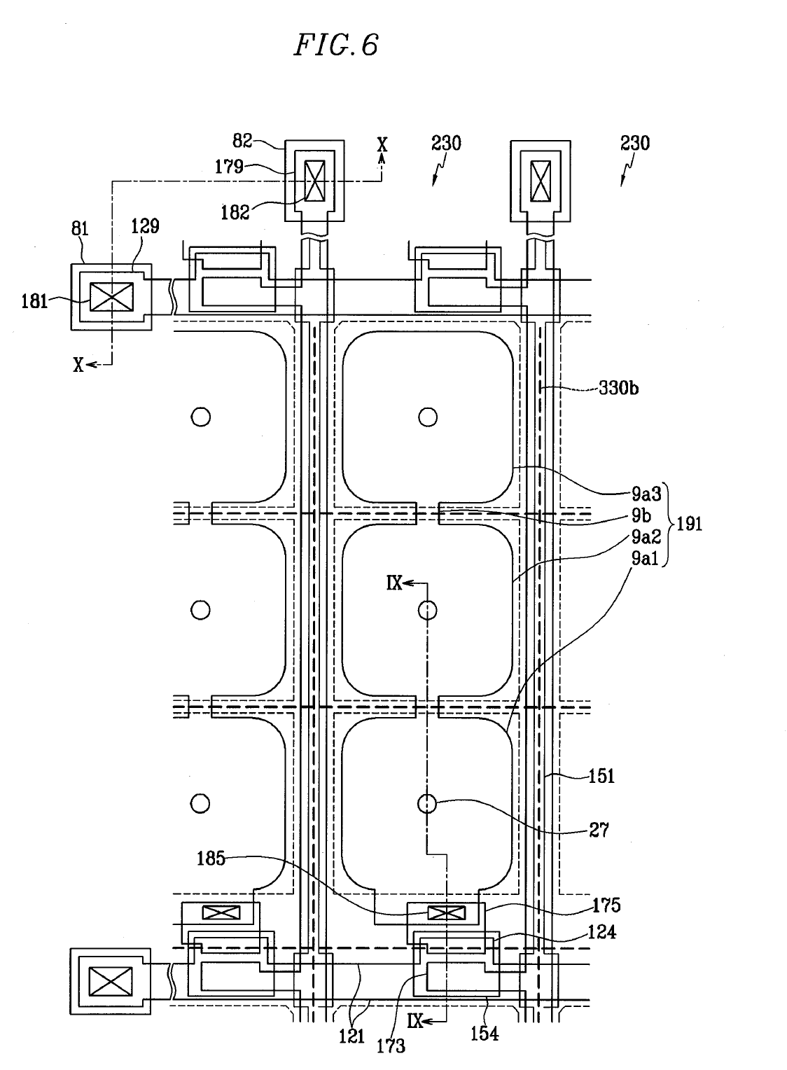

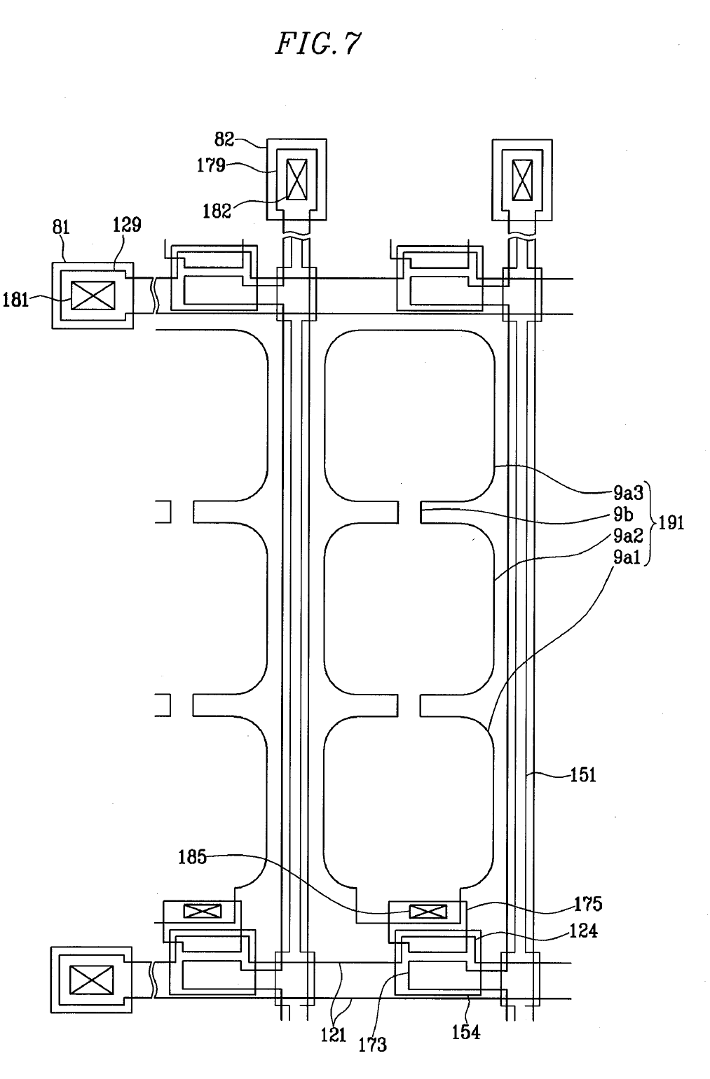

An LCD according to another embodiment of the present invention will now be described in detail with reference to FIGS. 6 and 7.

FIG. 6 is a layout view of an LCD according to another embodiment of the present invention, FIG. 7 is a layout view of a TFT array panel of the LCD shown in FIG. 6 according to an embodiment of the present invention,

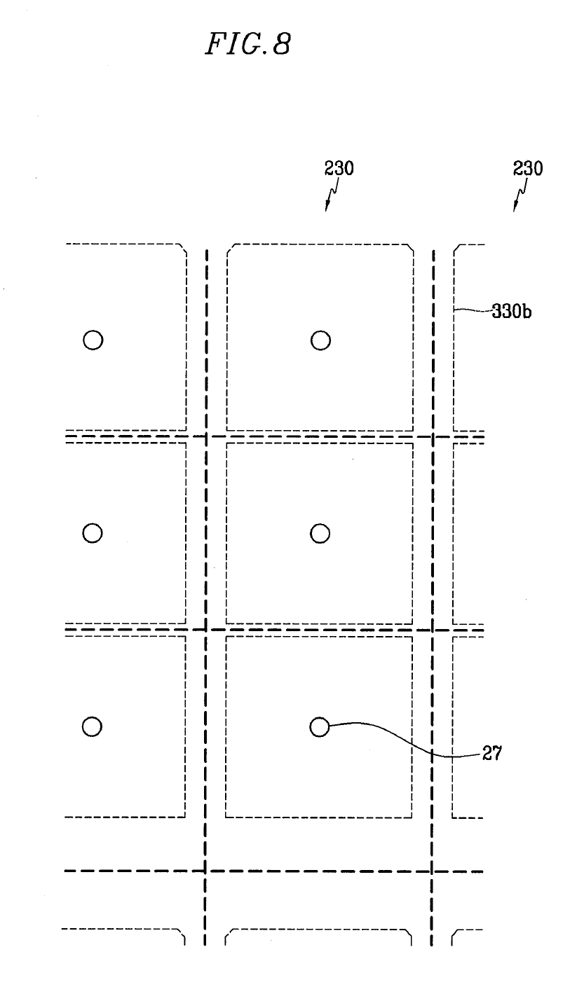

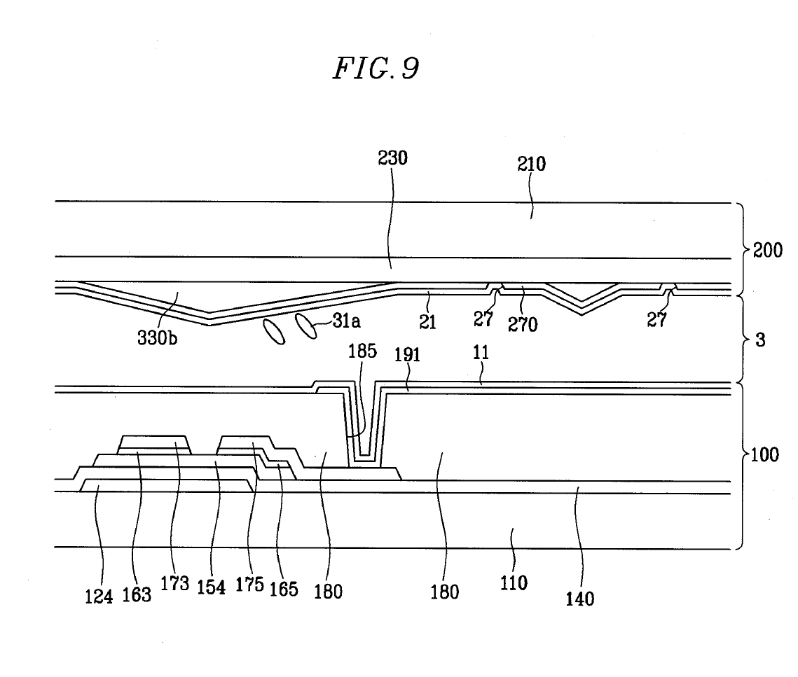

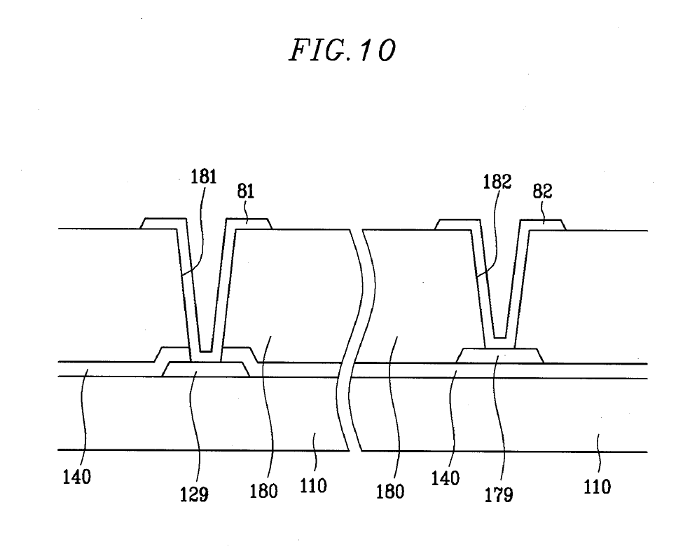

FIG. 8 is a layout view of a common electrode panel of the LCD shown in FIG. 6 according to an embodiment of the present invention, FIG. 9 is a sectional view of the LCD shown in FIG. 6 taken along the line IX-IX, and FIG. 10 is a sectional view of the LCD shown in FIG. 6 taken along the line X-X.

Referring to FIGS. 6 to 10, an LCD according to this embodiment also includes a TFT array panel 100, a common electrode panel 200, and an LC layer 3 interposed between the panels 100 and 200.

The TFT array panel 100 is now described in detail with reference FIGS. 6, 7, 9, and 10.

A plurality of gate lines 121 are formed on an insulating substrate 110 made of a material such as transparent glass.

Gate lines 121 extend substantially in a transverse direction and are separated from each other, and transmit gate signals. Each gate line 121 includes a plurality of projections forming a plurality of gate electrodes 124 projecting upward and an end portion 129 having a large area for contact with another layer or an external driving circuit.

In addition, the lateral sides of gate lines 121 are inclined relative to a surface of the substrate, and the inclination angles thereof are in a range of about 30 to 80 degrees.

A gate insulating layer 140 preferably made of silicon nitride (SiNx) is formed on gate lines 121 and storage electrode lines 131.

A plurality of semiconductor islands 154 and stripes 151 preferably made of hydrogenated amorphous silicon (abbreviated to “a-Si”) or polysilicon are formed on gate insulating layer 140. Each semiconductor island 154 is disposed on gate electrodes 124, and each semiconductor stripe 151 extends in the longitudinal direction and becomes wide near gate lines 121 such that semiconductor stripes 151 cover gate lines 121.

A plurality of ohmic contact islands 163 and 165 preferably made of silicide or n+ hydrogenated a-Si heavily doped with an n-type impurity such as phosphorous are formed on semiconductor islands 154. Ohmic contact islands 163 and 165 are located in pairs on semiconductor islands 154. A plurality of ohmic contact stripes (not shown) may be formed on semiconductor stripes 151.

The lateral sides of semiconductors 154 and 151 and ohmic contacts 163 and 165 are inclined relative to a surface of the substrate, and the inclination angles thereof are preferably in a range of between about 30 and 80 degrees.

A plurality of data lines 171 and a plurality of drain electrodes 175 separated from data lines 171 are formed on ohmic contacts 163 and 165 and gate insulating layer 140.

Data lines 171 for transmitting data voltages extend substantially in the longitudinal direction and cross gate lines 121 at right angles. Each data line 171 includes an end portion 179 having a large area for contact with another layer or an external device. Each data line 171 includes a plurality of source electrodes 173 projecting toward gate electrodes 124.

Each drain electrode 175 is separated from data lines 171 and faces the source electrodes 173 with respect to gate electrode 124.

Like gate lines 121, data lines 171 and drain electrodes 175 have tapered lateral sides, and the inclination angles thereof are in a range of about 30 to 80 degrees.

Ohmic contacts 163 and 165 are interposed only between the underlying semiconductor islands 154 and the overlying data lines 171 and the overlying drain electrodes 175 thereon, and reduce contact resistance therebetween. Semiconductor islands 154 include a plurality of exposed portions, which are not covered with data lines 171 and drain electrodes 175, such as portions located between the source electrodes 173 and drain electrodes 175. Semiconductor islands 154 include some exposed portions, which are not covered with the data conductors 171 and 175, such as portions located between the source electrodes 173 and drain electrodes 175.

A passivation layer 180 is formed on data lines 171, drain electrodes 175, and the exposed portions of semiconductors 154.

The passivation layer 180 has a plurality of contact holes 182 and 185 exposing the end portions 179 of data lines 171 and the end portions of drain electrodes 175, respectively. The passivation layer 180 and gate insulating layer 140 have a plurality of contact holes 181 exposing the end portions 129 of gate lines 121.

A plurality of pixel electrodes 191 and a plurality of contact assistants 81 and 82 are formed on the passivation layer 180.

Pixel electrodes include first to third sub-pixel electrodes 9a1, 9a2, and 9a3, which are arranged in a line and have a square shape with four rounded corners. First sub-pixel electrode 9a1 is connected to drain electrode through contact hole 185, and first to third sub-pixel electrodes 9a1, 9a2, and 9a3 are respectively connected to a connection 9b.

Contact assistants 81 and 82 are connected to the end portions 129 of gate lines 121 and the end portions 179 of data lines 171 through contact holes 181 and 182, respectively. Contact assistants 81 and 82 protect the end portions 129 and 179 and complement the adhesion of the end portions 129 and 179 and external devices.

A description of the common electrode panel 200 follows with reference to FIGS. 6, 8, and 9.

A plurality of color filters 230 are formed on an insulating substrate 210, and they are disposed substantially in the areas enclosed by the light blocking member 220. The color filters 230 may extend substantially along the longitudinal direction along pixel electrodes 191. The color filters 230 may represent one of the primary colors such as red, green, and blue colors.

A plurality of slope members 330b are formed in the color filters 230. The slope members 330b include a ridge indicated by a thick dotted line in FIG. 6, and an inclined surface of which the height is gradually reduced from the ridge to the edge of the slope members 330b. The edges portion of the slope members 330b is indicated by thin dotted lines in FIG. 6.

The slope members 330b are disposed in the regions corresponding to boundary portions between adjacent color filters 230 and the connections for connecting the sub-pixel electrodes 9a1, 9a2, and 9a3. Also, the slope members 330b may be formed at the locations corresponding to the TFTs.

A light blocking member called a black matrix for preventing light leakage in the portions between adjacent pixel electrodes 191 and other portions corresponding to the TFTs may be provided on the insulating substrate 210.

Accordingly, when the slope members 330b are located at the portions corresponding to the boundaries between adjacent color filters 230 and the portions corresponding to the connections of pixel electrodes 191 and TFTs, the slope members 330b may prevent light leakage without additional processes. Here, it is preferable that the slope members 330b are made of an organic material including a black resin. If the blocking member is additionally formed, the slope members 330b may be formed on the overcoat (not shown) and may be one body with the overcoat.

A common electrode 270 preferably made of a transparent conductive material such as ITO and IZO is formed on the overcoat 250, and is thicker than pixel electrode 191.

The common electrode 270 has a plurality of sets of circular cutouts 27. A set of the circular cutouts 27 faces the center of first to third sub-pixel electrodes 9a1 to 9a3.

Upon application of the common voltage to the common electrode 270 and a data voltage to pixel electrodes 191, an electric field substantially perpendicular to the surfaces of the panels 100 and 200 is generated. The LC molecules tend to change their orientations in response to the electric field such that their long axes are perpendicular to the field direction.

The circular cutouts 27 of the common electrode 270 and the edges of pixel electrodes 191 distort the electric field to have a horizontal component that is substantially perpendicular to the edges of the circular cutouts 27 and the edges of pixel electrodes 191. Accordingly, the LC molecules on each sub-pixel electrodes 9a1-9a3 are tilted in a direction by the horizontal component and the azimuthal distribution of the tilt directions are localized to four directions, thereby increasing the viewing angle of the LCD.

The LC molecules 31a are pre-tilted by the slope members 330b with arbitrary directions in the absence of the electric field. Accordingly, when the slope members 330b are disposed closer at the edges of the sub-pixel electrodes 9a1, 9a2, and 9a3, the pre-tilt directions of the LC molecules 31a determine the tilt directions of the LC molecules 31 upon application of the electric field, which coincide with the tilt directions determined by the electric field, therefore the response time of the LC molecules 31 may be increased.

Furthermore, the connections may distort the alignments of the LC molecules such that the LC molecules on the connection are aligned in arbitrary directions, but the LC molecules 31 are pre-tilted by the slope members 330a in arbitrary directions in the absence of the electric field. Accordingly, the collisions of the LC molecules are not generated, and therefore the afterimage due to the collisions is not generated.

As described above, the tilt directions of the LC molecules due to slope members coincide with the tilt directions determined by cutouts, and accordingly the arrangements of the LC molecules may be optimized and the afterimage may be prevented.

While the present invention has been described in detail with reference to the preferred embodiments, those skilled in the art will appreciate that various modifications and substitutions can be made thereto without departing from the spirit and scope of the present invention.

What is claimed is:

1. A liquid crystal display, comprising:
a first insulating substrate;
a gate line formed on first insulating substrate;
a data line intersecting gate line;
a thin film transistor connected to gate line and the data line;
a pixel electrode connected to the thin film transistor and having a plurality of slits;
a second insulating substrate facing first insulating substrate;
a slope member disposed on a location corresponding to the corner of pixel electrode and formed on second insulating substrate;
a common electrode formed on second insulating substrate; and
a liquid crystal layer formed between the common electrode and pixel electrode.

2. The liquid crystal display of claim 1, wherein the slits obliquely extend from right and left edges of pixel electrode to imaginary longitudinal and vertical center lines of pixel electrode.

3. The liquid crystal display of claim 1, wherein the plane shape of the slope member is circular or polygonal, and the slope member has a decreasing height from the center portion to the edge portion thereof.

4. The liquid crystal display of claim 1, wherein the molecules of the liquid crystal display under the slits are tilted in the longitudinal direction of the slits.

5. The liquid crystal display of claim 1, wherein the width of the slits is in the range of about 3-4 μm.

6. A liquid crystal display, comprising:
a first insulating substrate;
a gate line formed on first insulating substrate;
a data line intersecting gate line;
a thin film transistor connected to gate line and the data line;
a pixel electrode connected to the thin film transistor and having a plurality of sub-pixel electrodes;
a second insulating substrate facing first insulating substrate;
a slope member formed on second insulating substrate;
a common electrode formed on second insulating; and
a liquid crystal layer formed between the common electrode and pixel electrode.

7. The liquid crystal display of claim 6, wherein the slope member has vertical portions corresponding to the data line, and transverse portions corresponding to the connections of the sub-pixel electrode and connecting the vertical portions.

8. The liquid crystal display of claim 6, wherein the sub-pixel electrodes may have a rectangular shape having rounded corners.

9. The liquid crystal display of claim 6, wherein the common electrode has a plurality of cutouts disposed on the center of the sub-pixel electrodes.

10. A liquid crystal display having a wide viewing angle, comprising
a plurality of pixel electrodes and a common electrode for creating an electric field to influence the orientation of the liquid crystal molecules in the liquid crystal interposed between the pixel and common electrodes,
a plurality of pixel cutouts having a narrow width for distorting the electric field to form an electric field component respective to each edge, each said field component being substantially perpendicular to and offsetting the other so that the LC molecules are influenced by the shapes of cutouts rather than by the electric field due to cutouts, whereby the LC molecules are tilted in a direction parallel to the edges of the cutouts rather than perpendicular to the edges of the cutouts resulting in an increased viewing angle.

11. The liquid crystal display of claim 10 further comprising a plurality of slope members disposed at the corners of the pixel electrodes to alter the response time of the LC molecules.
